(19) United States
(12) Patent Application Publication
(10) Pub. No.: US 2013/0212469 A1
(43) Pub. Date: Aug. 15, 2013

(54) Web Reader for Readers with reading disabilities

(71) Applicant: Charles Yang Tian, Allen, TX (US)

(72) Inventor: Charles Yang Tian, Allen, TX (US)

(21) Appl. No.: 13/371,406

(22) Filed: Feb. 11, 2012

(51) Int. Cl. G06F 17/00

(52) U.S. Cl. 715/236; 715/234

(57) ABSTRACT

A method and system for providing a web reader for people with reading disabilities. A web browser extension is included with a web browser add-on functionality that changes a web content hypersensitive marking code at real time to use a cascading style sheet specifically designed for people with a reading disability.

### DESCRIPTION OF RELATED ART

The present application relates to a web browser plugin for providing added functionalities, and more particularly, a web reader that allows a reader with reading disabilities to read efficiently.

Note that the points discussed below may reflect the hindsight gained from the disclosed inventions, and are not necessarily admitted to be prior art.

A reading disorder or reading disability affects a person's ability to read. The most common reading disability is dyslexia, defined by the National Institute of Neurological Disorders and Stroke as “a brain-based type of learning disability that specifically impairs a person's ability to read. These individuals typically read at levels significantly lower than expected despite having normal intelligence. Although the disorder varies from person to person, common characteristics among people with dyslexia are difficulty with spelling, phonological processing (the manipulation of sounds), and/or rapid visual-verbal responding.”

Dyslexia is estimated to affect around 5-17% of the population. Dyslexics (those suffering from dyslexia) find normal reading more time consuming, energy consuming, and difficult. Dyslexics are prone to rotate, flip, or in other ways skew letters and symbols while processing them mentally, which often leads to them switching letters which are similar in appearance, deleting letters, and substituting letters. Visual noises that make recognizing a letter difficult is considered one of the causes. Certain elements in a font type attribute to the creation of visual noises.

Efforts have been made to design special font types in reducing visual noises. For example, Christopher Boer developed a font type “Dyslexie” in 2008, (http://www.studiostudio.nl/voorbeeld-teksten/) integrating adjustments in letter style and making the letter more readable to those with dyslexia.

Chris Corbett also designed two slightly different font types, “Gill Dyslexic” (http://www.pixelscript.net/gilldyslexic/) and “Mono Dyslexic,” (http://www.pixelscript.net/monodyslexic/) to enhance the readability and reading experience of people with dyslexia.

These font types may be individually purchased with the developers, and be installed and used individually for people with dyslexia to type words in an individually installed text editing software or to convert a font type into the Dyslexic fonts for each individual documents or Acrobat® pdf documents.

But for web publications on the internet, it is cumbersome and time consuming for readers with dyslexia every time manually to convert each and every web page into Dyslexic fonts to read. There is a need for functionalities to convert web pages into a Dyslexic font on the fly and at real time for people with dyslexia to be able to surf the web efficiently.

### SUMMARY

The present application discloses a novel add-on functionality for web browsers to covert a web page in any font type into a font type that makes it easy for people with reading disabilities.

In one embodiment, a web browser add-on functionality implements a GreaseMonkey™ interface, and is activated when a web browser is activated and the add-on functionality checks for the currently loaded web content for texts, if texts is found in the web content, a GreaseMonkey's GM_addStyle like function is called to add a new CSS command to the web page html code that overrides the prior CSS string in the web page, and calls for a new style sheet that uses a font set specifically designed for people with reading disabilities.

In one aspect of an embodiment, the font set specifically designed for people with reading disabilities is either located on the local computer or is located on a remote computer linked through the internet.

In one aspect of an embodiment, the loading of a specific CSS style sheet is specified by a user at the installation, and can be changed through changing the property of the add-on.

In one aspect of an embodiment, more than one sets of specifically designed fonts are allowed to be installed and be selected by changing the setting of the adds-on functionality, each font type corresponds to a different reading disabilities.

In one embodiment, the add-on functionality is built into a web browser and the functionality is activated by checking it at the optional settings.

The disclosed innovation, in various embodiments, provide one or more of at least the following advantages. However, not all of these advantages result from every one of the innovations disclosed, and this list of advantages does not limit the various claimed inventions.
Enabling people to read the web pages more efficiently;
For one simple installation, all web pages are automatically converted into web pages with special font types on the fly and at real time.
With option for setting up properties, the flexibility to accommodate different types of users.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows the functional relationships of the operative components of a web browser in accordance to this application.

FIG. 2 schematically shows an example of functional flow charts of the operative steps of a web browser enabling efficient reading for people with reading disabilities in accordance to this application.

FIG. 3 shows an example web browser loaded with a Reader for people with Dyslexia in accordance with this application.

FIGS. 4A and 4B show an example installation and activation process from a web browser in accordance with this application.

FIG. 5 shows a converted wen page of FIG. 3 in which the text is displayed with a Dyslexia specific font in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

It is contemplated and intended that the method described apply to all web browsers; for clarity reason, the examples are given based on Google® Chrome. but an ordinary person in the art would know the variations to modify the method and process to work with other web browsers.

The application is operable on a PC, on an Apple Mac computer, on a cellular phone, on tablet and handheld personal devices and other computer systems that runs internet and web browsers.

The Document Object Model (DOM) is a cross-platform and language-independent convention for representing and interacting with objects in HTML, XHTML and XML documents. Aspects of the DOM (such as its “Elements”) may be addressed and manipulated within the syntax of the programming language in use. Greasemonkey™ (https://addons.mozilla.org/en-US/firefox/addon/greasemonkey/) is an open source, mainly Mozilla Firefox browser extension that allows users to install scripts that make on-the-fly changes to HTML web page content on the DOM Content Loaded event, which happens immediately after it is loaded in the browser. With the help of GreaseMonkey™ functionality, a web browser can be modified to provide web pages on the fly at the user's end for people with reading disabilities. The background and knowledge of GreaseMonkey™ functionalities are common knowledge for GreaseMonkey™ developers and community. An ordinary person in the art may also modify the functionality and create a similar user interface to interact with other web browsers, such as the Microsoft® internet explorer, Apple® Safari. In this application, the example uses Google® Chrome.

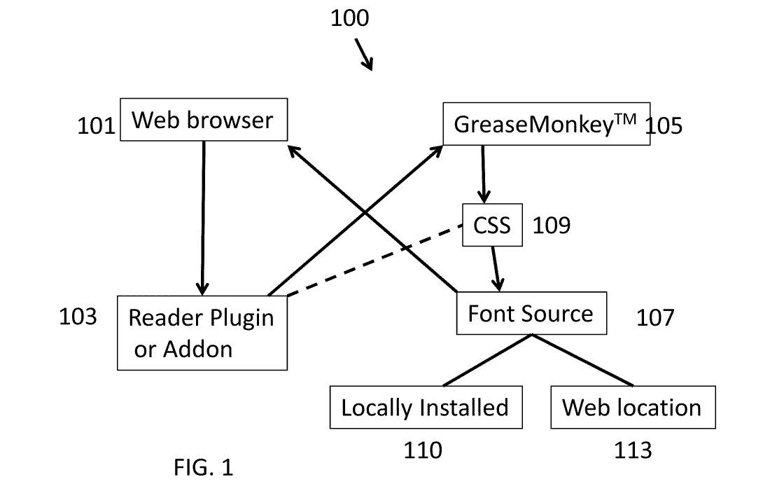

In reference to FIG. 1, a modified web browser 100 includes a regular web browser 101, a reader plugin functionality 103, a GreaseMonkey functionality 105, a CSS (Cascading Style Sheets) 109 specific for people with reading disabilities, specific font source 107 designed for people with reading disabilities. The font source may be either locally installed 110 or at a specific internet location 113.

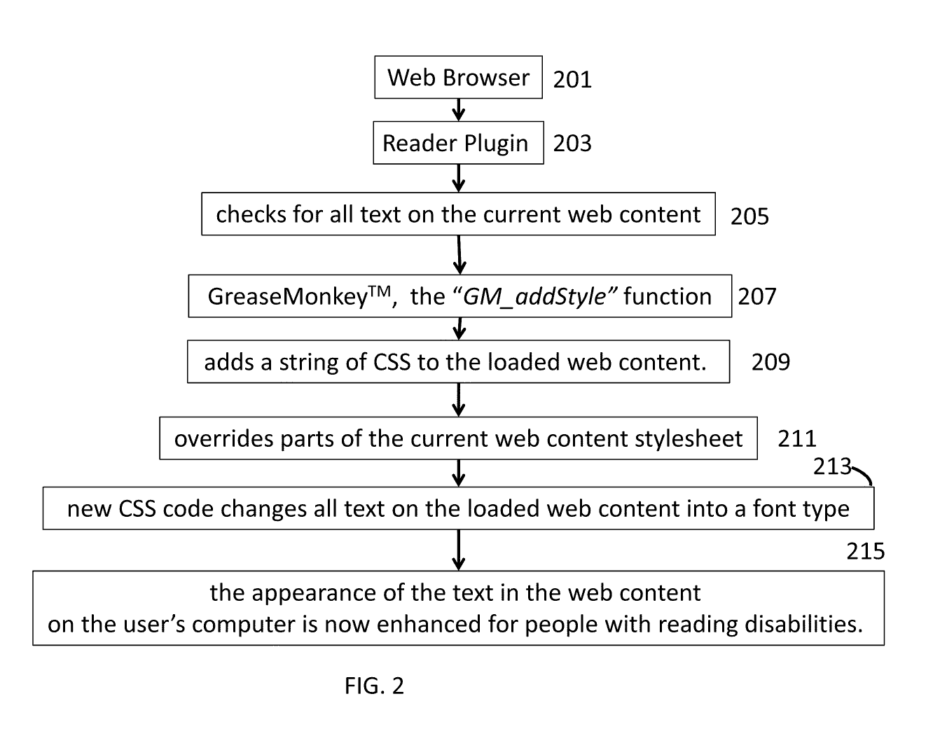

In reference to FIG. 2, the functional process of a modified web browser 100 is shown. When a web browser is activated at step 201, it calls on the Reader plugin controller functionality at step 203. Reader plugin controller functionality checks for the presence of any text content of the currently loaded web content at step 205, and then calls on GreaseMonkey™ the GM_addStyle functionality at step 207. GM_addStyle functionality then changes the command codes of the web page's html code at step 209 and inserts a new command to load a new cascading style sheet at step 211. The new cascading style sheet code directs the web browser to load a new font type specifically designed for people with reading disabilities at step 213. The web browser then displays the text content of the current web page using the font types specified by the new CSS sheet at step 215.

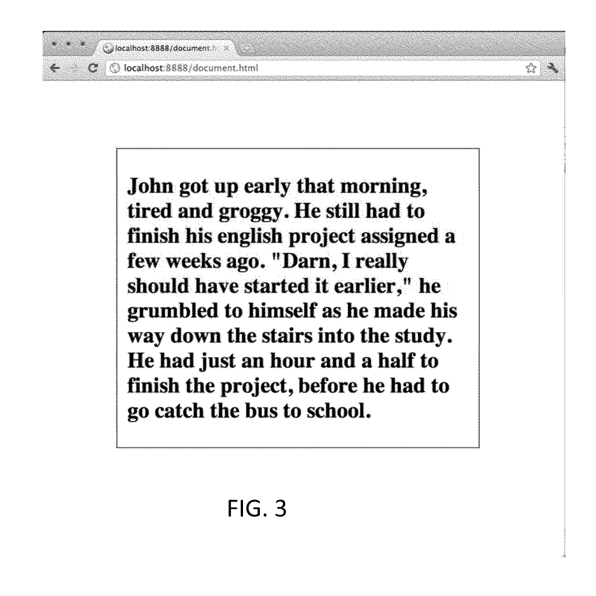

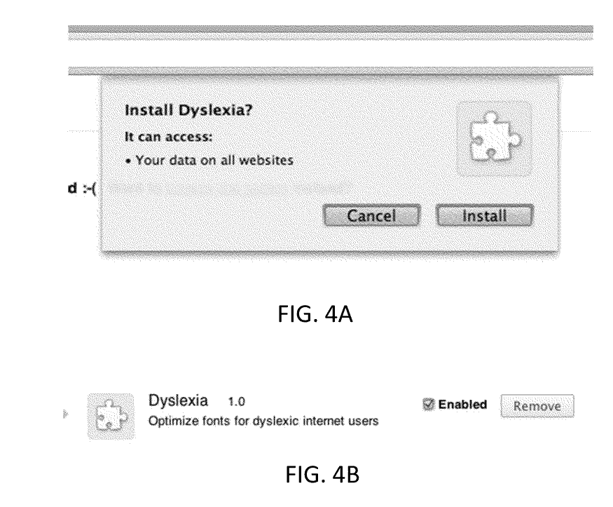

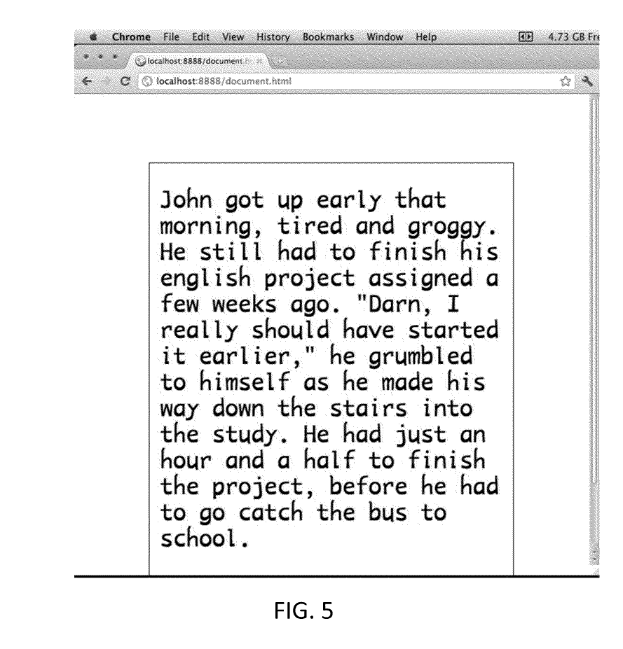

In reference to FIG. 3, it shows a conventional web browser displaying a set of text content. FIGS. 4A and 4B shows an example installation of the Reader functionality that includes the installation of GreaseMonkey browser extension and the new CSS sheet. By default, a set of font types are also included. FIG. 5 shows the modified browser that displays the text content in FIG. 3 in a set of Dyslexia font type which enables people with dyslexia reading disabilities to read more efficiently.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A computing device installed with an improved web browser functionality, comprising:
a first computing processing module loaded with said improved web browser functionality comprises:
a browser extension able to interact real time with a web content loaded by said web browser functionality; and
a controller functionality for interacting with said browser extension,
wherein said controller functionality is activated to call on said browser extension which then changes a command code of said web content to a second command code, causing said web browser functionality to display a text content in special fonts.

2. The computing device of claim 1, wherein said second command code calls on a cascading style sheet designed for a person with Dyslexia.

3. The computing device of claim 1, wherein said browser extension is a GreaseMonkey™ functionality.

4. The computing device of claim 1, wherein said controller functionality is configured to be turned on and turned off by a user.

5. A method for providing a web reader for a person with a reading disability, comprising the steps of:
providing a browser extension able to interact real time with a web content loaded by a web browser functionality;
providing a controller functionality for interacting with said browser extension; and
providing a cascading style sheet designed for said person with said reading disability,
wherein said controller functionality is activated to call on said browser extension which in turn changes a command code of said web content to use said cascading style sheet, and said web browser functionality displays a text content in accordance with said cascading style sheet.

6. The computing device of claim 5, wherein said cascading style sheet is designed for a person with Dyslexia.

7. The computing device of claim 5, wherein said browser extension is a GreaseMonkey™ functionality.

8. The computing device of claim 5, wherein said Reader add-on is configured to be turned on and turned off by a user.
